(19) United States
(12) Patent Application Publication
(10) Pub. No.: US 2026/0091510 A1
(43) Pub. Date: Apr. 2, 2026

(54) SUBSTRATE TRANSFER APPARATUS AND SUBSTRATE TRANSFER METHOD

(71) Applicants: KAWASAKI JUKOGYO KABUSHIKI KAISHA, Kobe-shi (JP); Kawasaki Robotics (USA), INC., Wixom, MI (US)

(72) Inventors: Haruhiko TAN, Kobe-shi (JP); Hajime NAKAHARA, San Jose, CA (US)

(73) Assignees: KAWASAKI JUKOGYO KABUSHIKI KAISHA, Kobe-shi (JP); Kawasaki Robotics (USA), INC., Wixom, MI (US)

(21) Appl. No.: 18/901,497

(22) Filed: Sep. 30, 2024

(51) Int. Cl. B25J 15/00; B25J 11/00

(52) U.S. Cl. CPC B25J 15/0014; B25J 11/0095

(57) ABSTRACT

A substrate transfer apparatus according to one or more embodiments may include substrate transfer apparatus including: an end effector including: a hand that grips a substrate; and a plunger that comes into contact with the substrate and performs alignment of the substrate comprising a contact portion that comes into contact with the substrate by moving in a substrate direction. A contact portion of the substrate transfer apparatus according to one or more embodiments includes a contact bottom surface that comes into contact with the substrate and is inclined so that a thickness decreases toward a tip of the contact portion.

### BACKGROUND

The disclosure relates to a substrate transfer apparatus and a substrate transfer method, particularly to a substrate transfer apparatus for gripping and transferring a semiconductor substrate or the like.

A plurality of manufacturing apparatus is used when manufacturing semiconductor substrates, liquid crystal substrates, panels, and the like (hereinafter referred to as substrate). A transfer apparatus is used to transfer substrates between these manufacturing devices. The transfer apparatus includes industrial robots.

The Japanese Patent Publication 2018-73942 (P2018-73942A) discloses a substrate gripping hand for gripping a disc-shaped substrate, which is provided with a guide member on the base plate, formed in an L-shape when viewed horizontally, and a horizontal portion is provided at the base end of the bottom surface of the guide member, and a first corner that is a corner formed by the bottom surface and the inner wall surface of the guide member is formed in a curved shape.

The Japanese Patent Publication 2014-86472 (P2014-86472A) discloses a clamping device capable of holding and releasing the workpiece, including a tip side fixing block provided on the tip side, a base side fixing block provided on the base side, and a movable block on the work holding table. Each fixed block is formed with an upward-facing fixed inclined surface, and the movable block is formed with a downward-facing movable inclined surface, and when holding the workpiece, while the workpiece is placed straddling the upward fixed inclined surface, the movable block is advanced so that the downward movable inclined surface is in contact with the side of the workpiece, and when the workpiece is released from the work holding table, the movable block is retracted in the opposite direction from the workpiece.

### SUMMARY

A substrate transfer apparatus according to one or more embodiments may include an end effector including: a hand that grips a substrate; and a plunger that comes into contact with the substrate and performs alignment of the substrate comprising a contact portion that comes into contact with the substrate by moving in a substrate direction. In one or more embodiments, the contact portion may comprise a contact bottom surface that comes into contact with the substrate and is inclined so that a thickness decreases toward a tip of the contact portion.

A substrate transfer method according to one or more embodiments may including: moving a contact portion driven by a plunger in a substrate direction; contacting a substrate with a contact bottom surface of the contact portion, wherein the contact bottom surface is inclined so that its thickness decreases toward a tip of the substrate; moving the contact portion in the substrate direction by the plunger, the substrate is in contact with a contact side of a contact side surface; and gripping the substrate with the contact side surface.

### BRIEF DESCRIPTION OF DRAWINGS

FIG. 1 is a diagram illustrating an upper surface of a substrate transfer apparatus according to one or more embodiments.

FIG. 2A is a diagram illustrating a top view of a portion of an end effector according to one or more embodiments.

FIG. 2B is a diagram illustrating a cross-sectional view of a portion of an end effector according to one or more embodiments.

FIGS. 3A, 3B, 3C, and 3D are diagrams illustrating cross-sectional views of an end effector.

FIGS. 4A, 4B, 4C, and 4D are diagrams illustrating examples of a contact portion according to one or more embodiments.

FIG. 5A is a diagram illustrating a moving acceleration of a substrate when a substrate transfer apparatus including a contact portion having a vertical surface in the Z direction grips a substrate.

FIG. 5B is a diagram illustrating a moving acceleration of a substrate when a substrate transfer apparatus including a contact portion according to one or more embodiments grips a substrate.

FIG. 6 is a diagram illustrating an upper surface of a substrate transfer apparatus according to one or more embodiments.

### DETAILED DESCRIPTION

A substrate transfer apparatus according to one or more embodiments is described in detail with reference to the drawings. In the description of the drawings, identical or similar parts may be indicated by the same or similar numerals. The description in the drawing is schematic, and the relationship between thickness and dimensions, the ratio of the length and thickness of each part, etc. are examples, and do not limit the scope of technical concept. Dimensional relationships and dimension ratios may vary between drawings. In the following description, when explaining the positional relationship of each component, “top”, “bottom”, “right side”, “left side”, etc. are appropriately used based on the orientation of the drawing to be referenced and the specific object, but these indications do not limit the scope of technical thought. Expressions such as “top”, “bottom”, “right side”, “left side”, etc. may be used even when each part is not touched. “Longitudinal direction” may mean the direction of the long side on the main surface of the member. “Width direction” may mean the direction of the short side on the main surface of the member. “Height direction” or “vertical direction” may mean a direction related to the thickness of the main surface of the member. In addition, the X axis, the Y axis, the Z axis, or a combination thereof may be displayed in the figure, and “X axis direction”, “Y axis direction”, and “Z axis direction” may be used in the specification or drawing to describe the direction.

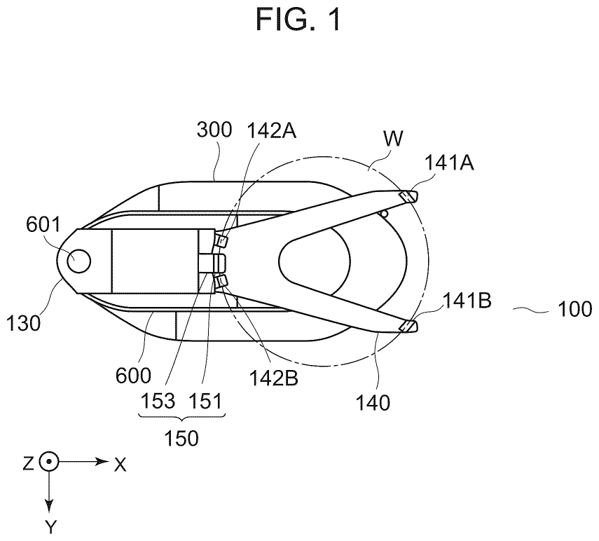

FIG. 1 is a diagram illustrating the upper surface of the substrate transfer apparatus 100 according to one or more embodiments. The substrate transfer apparatus 100 includes a base 300, a link 600 rotatably connected to the base 300, and an end effector 130 that is rotatably connected around the rotation shaft 601 and transfers the substrate W. The substrate transfer apparatus 100 may include an extendable elevator (not shown) that may move the link 600 and the end effector 130 in the vertical direction (Z direction shown). Although only one link 600 is illustrated in FIG. 1, the substrate transfer apparatus 100 may include two (2), three (3), four (4), or five (5) links 600. Further, the substrate transfer apparatus 100 may not include a link 600 and may directly connect the end effector 130 to an elevator (not shown). Furthermore, the substrate transfer apparatus 100 may not include an elevator and may be directly connected to one or more links to the base 300. The substrate transfer apparatus 100 in FIG. 1 particularly indicates a horizontally articulated substrate transfer apparatus, but is not limited thereto, and a so-called direct-acting type substrate transfer apparatus that does not have a joint or a rotation mechanism may also be implemented. In the substrate transfer apparatus 100, various operations are controlled by a controller (not shown). The controller performs various operation controls including lifting and lowering operations and rotation operations of the elevator, link 600, and end effector 130, etc.

The end effector 130 includes a hand 140 that grips a substrate such as a semiconductor substrate or a liquid crystal substrate, and various panels (hereinafter referred to as the substrate W), and a plunger 150 that grips and aligns the substrate in contact with the substrate W. The hand 140 includes substrate contact portions 141A, 141B, 142A, and 142B. The plunger 150 includes a contact portion 151 that may be moved to grip the substrate W. Under the control of the controller, the end effector 130 acquires the substrate W from a predetermined position using the hand 140 and transfers the substrate W to the predetermined position. When acquiring the substrate W stored in the FOUP (Front Opening Unified Pod) or the like, the hand 140 enters the upper or lower part of the substrate W, and when it is recognized that the hand 140 has entered to a predetermined position on the substrate W, the approach of the hand 140 is stopped. Thereafter, a gripping operation of the substrate W is performed. At this time, the contact portion 151 of the plunger 150 moves and grips the substrate W. As a method by which the hand 140 grips the substrate W, a so-called edge grip method may be used. In the edge grip method, the substrate W is held to some extent by the substrate contact portions 141A, 141B, 142A, and 142B, and the contact portion 151 is moved to touch the substrate W. Thereby, the contact portion 151 grips the substrate W. Thereby, the end effector 130 may grip the substrate W and transfer the substrate W to a predetermined position.

The substrate W includes a substrate such as a semiconductor substrate and a liquid crystal substrate and various panels. For example, the substrate W shown in FIG. 1 is circular, but is not limited thereto. The substrate W may be a transparent material containing a material that transmits light, or may be translucent, or non-transparent.

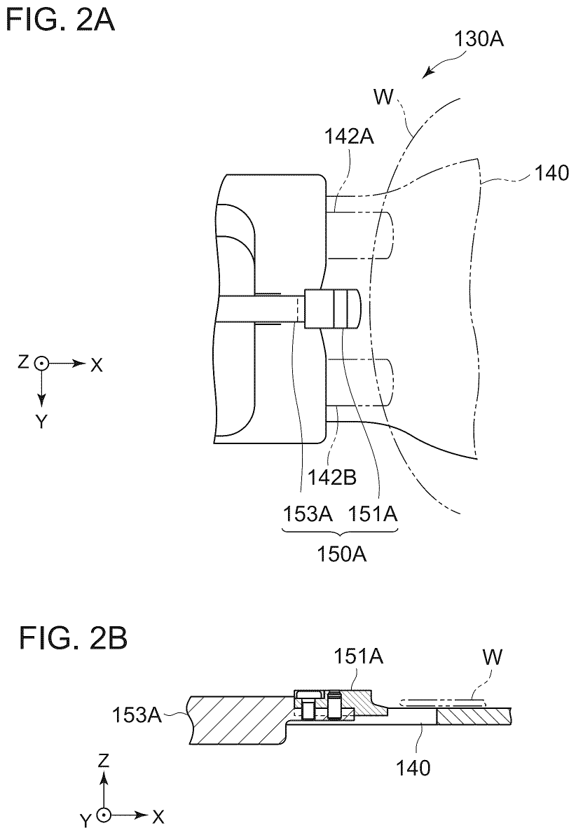

FIG. 2A is a top view showing a portion of the end effector 130A according to one or more embodiments. In FIG. 2A, the hand 140 is omitted for convenience of explanation. The end effector 130A includes a plunger 150A. The plunger 150A includes a contact portion 151A that comes into contact with the substrate W and secures the substrate, and a holder 153A that holds the contact portion 151A and makes the contact portion 151A movable. The holder 153A is connected to the shaft (not shown). The shaft is connected to the holder 153A at the first end, and the second end is connected to the drive unit (not shown). By applying power to the shaft, the drive unit performs a reciprocating motion, for example, in the longitudinal direction of the shaft (X direction shown). The holder 153A also moves back and forth with the reciprocating motion of the shaft. With the reciprocating movement of the holder 153A, the contact portion 151A moves and contacts the substrate to secure the substrate.

FIG. 2B is a cross-sectional view showing a portion of the end effector 130A according to one or more embodiments. As shown, when acquiring the substrate W, when the hand 140 enters the lower part of the substrate W, and when it is recognized that the hand 140 has entered to a predetermined position of the substrate W, the approach of the hand 140 is stopped and the substrate W is placed on the hand 140. Thereafter, a gripping operation of the substrate W is performed. During the gripping operation of the substrate W, since the drive of the drive unit may be transmitted to the contact portion 151, the shaft and the contact portion 151A may be directly connected. In other words, the holder 153A is not always necessary. Further, since the drive of the drive unit may be transmitted to the contact portion 151A, the contact portion 151A may be connected to the drive unit. In other words, the shaft is not always necessary. The drive unit that provides power for reciprocating the contact portion 151A may include a motor or a cylinder. When a motor is used as the drive unit, the position, speed, and torque may be accurately controlled to achieve delicate motion control. Further, by using a motor, the gripping force of the contact portion 151A may be finely adjusted. On the other hand, cylinders include hydraulic cylinders and pneumatic cylinders. Hydraulic cylinders are capable of high power and precise control. In addition, pneumatic cylinders are lightweight and capable of high-speed motion control. In general, cylinders are suitable for power sources of simple linear motion. On the other hand, complex motion control and position control by cylinders may be inferior to motors. In one or more embodiment, since complex control is not required when gripping the substrate, damage to the substrate may be minimized even if a cylinder is used.

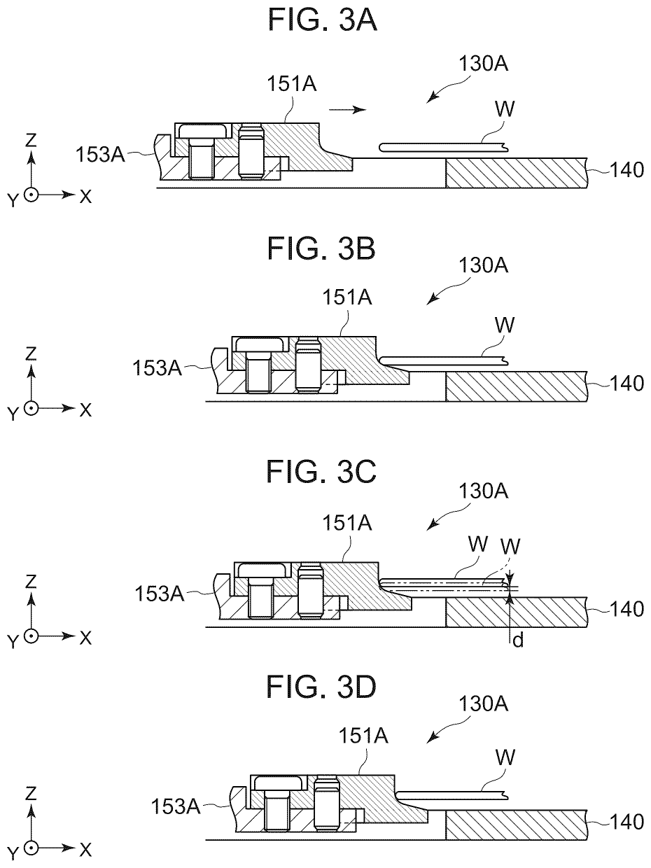

FIGS. 3A, 3B, 3C, and 3D are diagrams illustrating cross-sectional views of the end effector 130A. Using these figures, the operation of the end effector 130A gripping the substrate W is explained. FIG. 3A is a diagram showing a state in which the substrate W is placed on the hand 140. First, the contact portion 151A moves in the direction approaching the substrate W (X direction) by the holder 153A. FIG. 3B is a diagram showing a state in which the contact portion 151A is in contact with the substrate W. When the contact portion 151A moves in the X direction and contacts the substrate W, the substrate W may be damaged because the contact portion 151A moves at a predetermined speed. For example, since the contact portion 151A touches the edge of the substrate W, chipping of the edge of the substrate may occur. FIG. 3C is a diagram showing a state in which the contact portion 151A comes into contact with the substrate W and gripping. The contact portion 151A moves further in the X direction after contacting the substrate W. Here, the contact portion 151A according to one or more embodiments includes a contact bottom surface that is a bottom surface in which the substrate W is in contact, and a side surface in which the substrate W is in contact. Further, in the contact portion 151A, the contact boundary surface connecting the contact bottom surface and the contact side surface in which the substrate W is in contact is a curved surface. The bottom surface of the contact portion 151A is inclined so that the thickness decreases as it moves toward the tip direction (X direction). In FIG. 3C, the substrate W is first in contact with the bottom surface of the contact portion 151A. Thereafter, with further movement of the contact portion 151A in the X direction, the substrate W that came into contact with the bottom surface of the contact portion 151A moves the distance d in the upward direction (Z direction) on the contact bottom surface, follows the curved contact surface, and reaches the contact side surface. Since the contact boundary surface of the contact portion 151A according to one or more embodiments is curved, the impact on the substrate W is reduced. FIG. 3D is a diagram showing a state in which the contact portion 151A grips the substrate W. The contact portion 151A stops at a position where the substrate W may be fully gripped. Thereafter, the substrate transfer apparatus 100 transfers the substrate W to a predetermined location.

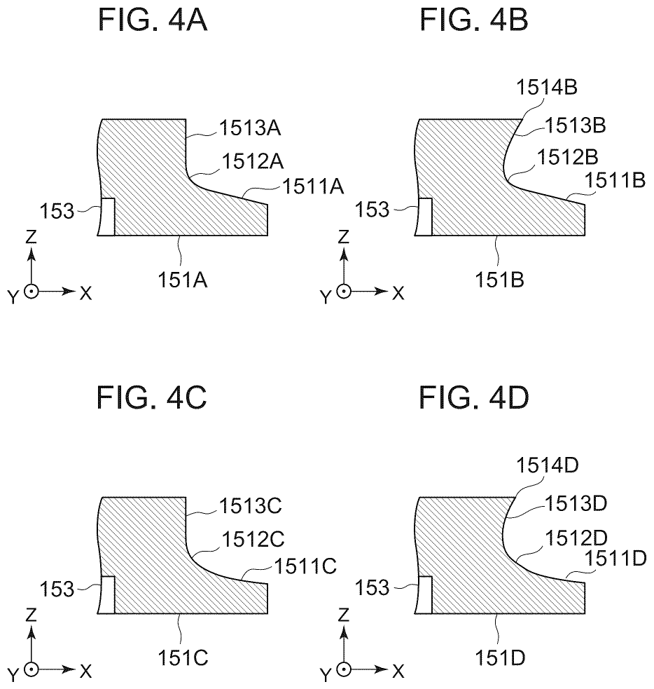

FIGS. 4A, 4B, 4C, and 4D are diagrams illustrating examples of the contact portion according to one or more embodiments. FIG. 4A shows an example of the contact portion 151A. The contact portion 151A includes a contact bottom surface 1511A which is a bottom surface on which the substrate (not shown) is in contact, and a contact side surface 1513A that is a side surface on which the substrate is in contact. Further, the contact portion 151A includes a contact boundary surface 1512A which connects the contact bottom surface 1511A and the contact side surface 1513A in which the substrate is in contact. As illustrated in the figure, the contact bottom surface 1511A is inclined so that its thickness decreases toward the tip direction (X direction). In other words, the contact bottom surface 1511A is inclined in the opposite direction to the Z direction toward the tip direction. The contact side surface 1513A is extended in the approximately vertical direction (Z direction). The contact boundary surface 1512A is curved in an arc.

FIG. 4B shows an example of the contact portions 151B. The contact portion 151B includes a contact bottom surface 1511B which is a bottom surface on which the substrate (not shown) is in contact, and a contact side surface 1513B that is a side surface on which the substrate is in contact. Further, the contact portion 151B includes a contact boundary surface 1512B connecting the contact bottom surface 1511B and the contact side surface 1513B in which the substrate is in contact. As illustrated in the figure, the contact bottom surface 1511B is inclined so that its thickness decreases toward the tip direction (X direction). In other words, the contact bottom surface 1511A is inclined in the opposite direction to the Z direction toward the tip direction. The contact side surface 1513B is gently curved in the X direction toward nearly vertical (Z direction). In other words, the vertex 1514B in the Z direction of the contact side surface 1513B is located in the X direction than the contact boundary surface 1512B. When the contact portion 151B comes into contact with the substrate and gripping, the contact portion 151B contacts the substrate and then moves further in the X direction. At this time, there is a possibility that the substrate moves rapidly in the Z direction and comes off from the contact portion, resulting in inaccurate gripping operation. According to the contact portion 151B shown in FIG. 4B, the contact side surface 1513B is gently curved in the X direction toward almost vertical (Z direction), and the curvature extends in the X direction, which may reduce the possibility of the substrate coming off the contacting portion even if the substrate moves rapidly in the Z direction.

FIG. 4C shows an example of the contact portion 151C. The contact portion 151C includes a contact bottom surface 1511C, which is a bottom surface on which the substrate (not shown) is in contact, and a contact side surface 1513C, which is a side surface on which the substrate is in contact. Further, the contact portion 151C includes a contact boundary surface 1512C that connects the contact bottom surface 1511C and the contact side surface 1513C in which the substrate is in contact. As shown, the contact bottom surface 1511C is inclined so that its thickness decreases while gently curving toward the tip direction (X direction). In other words, the contact bottom surface 1511C is gently curved toward the tip and inclined in the opposite direction to the Z direction. The contact side surface 1513C is extended in the almost vertical direction (Z direction). The contact boundary surface 1512C is curved in an arc. Here, the curvature of the contact boundary surface 1512C may be greater than the curvature of the contact bottom surface 1511C.

FIG. 4D shows an example of the contact portion 151D. The contact portion 151D includes a contact bottom surface 1511D, which is a bottom surface on which the substrate (not shown) is in contact, and a contact side surface 1513D, which is a side surface on which the substrate is in contact. Further, the contact portion 151D includes a contact boundary surface 1512D that connects the contact bottom surface 1511D and the contact side surface 1513D in which the substrate is in contact. As shown in the figure, the contact bottom surface 1511D is gently curved toward the tip direction (X direction) and is inclined so that its thickness decreases. In other words, the contact bottom surface 1511D slopes in the opposite direction to the Z direction while gently curving toward the tip direction. The contact side surface 1513D gently curves in the X direction toward almost vertical (Z direction). In other words, the vertex 1514D in the Z direction of the contact side surface 1513D is located in the X direction than the contact boundary surface 1512D.

FIGS. 4A, 4B, 4C and 4D were referenced to describe the shape of the contact portion, but the substrate contact portions 141A, 141B, 142A, and 142B may also have shapes according to FIGS. 4A, 4B, 4C and 4D.

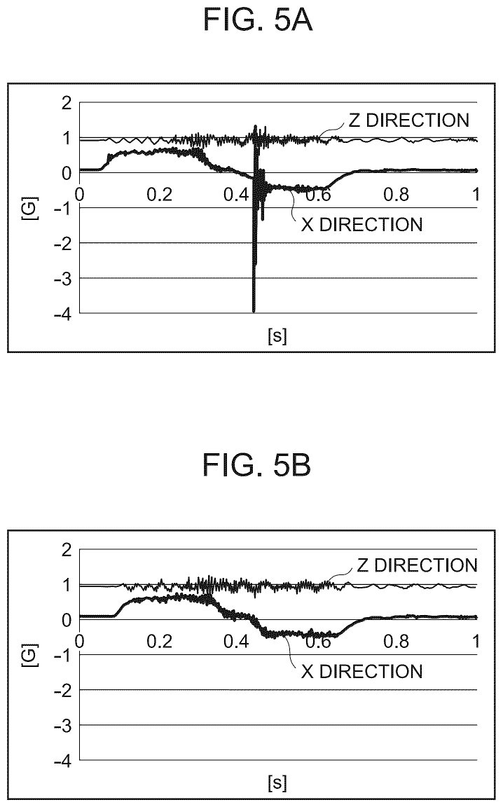

FIG. 5A is a diagram showing the moving acceleration of the substrate when a substrate transfer apparatus including a contact portion having a vertical surface in the Z direction grips the substrate. In FIG. 5A, the horizontal axis is time (in seconds), and the vertical axis is acceleration (G). In FIG. 5A, the substrate is brought into contact with the contact portion in the vicinity of more than 0.4 seconds, thereby causing a strong acceleration in the X direction. That is, a certain amount of impact is generated when the substrate comes into contact with the contact part. On the other hand, FIG. 5B is a diagram showing the moving acceleration of the substrate when the substrate transfer apparatus including the contact portion 151A having the shape of FIG. 4A grips the substrate. In FIG. 5B, the horizontal axis is time (in seconds), and the vertical axis is acceleration (G). In FIG. 5B, the substrate is brought into contact with the contact portion in the vicinity of more than 0.4 seconds, but there is no significant acceleration in the X direction compared to FIG. 5A. That is, the impact generation may be reduced when the substrate is in contact with the contact portion. Thereby, damage to the substrate may be reduced when the contact portion is in contact with the substrate. In FIGS. 5A and 5B, the time for which the substrate transfer apparatus holds the substrate is in contact with the substrate in about 0.4 seconds after the movement of the adjacent portion is started, and gripping is performed in about 0.7 seconds, but this is not limited to this time. For example, the time for which the substrate transfer apparatus holds the substrate may come into contact with the substrate for about 0.2 seconds or more and 0.6 seconds or less after the movement of the contact portion begins. Further, with regard to the gripping time, the gripping operation may be completed in about 0.5 seconds or more and about 1 second after the movement of the contact portion is started.

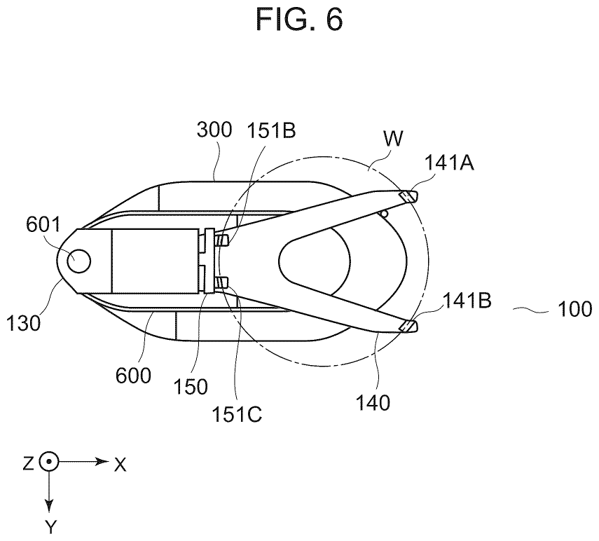

FIG. 6 is a diagram showing the upper surface of the substrate transfer apparatus 101 according to one or more embodiments. The substrate transfer apparatus 101 includes a base 300, a link 600 rotatably connected to the base 300, and an end effector 130 that is rotatably connected around the rotation shaft 601 and transfers the substrate W. The substrate transfer apparatus 101 may include an extendable elevator (not shown) that may move the link 600 and the end effector 130 in the vertical direction (in the Z direction shown in FIG. 6). Further, the substrate transfer apparatus 101 in FIG. 6 illustrates only one link 600, but is not limited thereto, and may include two, three, four, and five links 600. Further, the substrate transfer apparatus 101 may not include a link 600 and may directly connect the end effector 130 to an elevator (not shown). Further, the substrate transfer apparatus 100 may not include an elevator and may be directly connected to one or more links to the base 300. The substrate transfer apparatus 101 in FIG. 6 particularly indicates a horizontally articulated substrate transfer apparatus, but is not limited thereto, and a so-called direct-acting type substrate transfer apparatus that does not have a joint or a rotation mechanism may also be implemented. In the substrate transfer apparatus 101, various operations are controlled by a controller (not shown). The controller performs various operation controls of the elevator, link 600, and end effector 130, including lifting and lowering operations and rotation operations.

The end effector 130 includes a hand 140 that grips a substrate such as a semiconductor substrate, a liquid crystal substrate and various panels, and a plunger 150A that grips and aligns the substrate in contact with the substrate W. The hand 140 includes substrate contact portions 141A and 141B. The plunger 150A includes a plurality of contact portions 151B and 151C that may be moved to grip the substrate W. Under the control of the controller, the end effector 130 acquires the substrate W from a predetermined position using the hand 140 and transfers the substrate W to the predetermined position. When acquiring the substrate W stored in the FOUP (Front Opening Unified Pod) or the like, the hand 140 enters the upper or lower part of the substrate W, and when it is recognized that the hand 140 has entered to a predetermined position on the substrate W, the approach of the hand 140 is stopped. Thereafter, a gripping operation of the substrate W is performed. At this time, a plurality of contact portions 151B and 151C of the plunger 150A move and grip the substrate W. As a method by which the hand 140 grips the substrate W, a so-called edge grip method may be used. In the edge grip method, the substrate W is held to some extent by the contact portions 151B and 151C and the substrate contact portions 141A and 141B, and the contact portions 151B and 151C are moved to touch the substrate W. Thereby, the contact portions 151B and 151C grip the substrate W.

One or more embodiments described above herein may be combined with each other as far as practicable within the scope of the intended embodiment. The above examples are exemplary in all respects and should be considered not limiting. The illustrated and described embodiments may be extended to include other embodiments in addition to those specifically delivered, without departing from the technical scope. The technical scope should be determined not only by the foregoing description, but also in the light of the specification containing equivalents. Thus, all configurations, including the technical and equal ranges, are intended to be included in the technical range. The entire contents of U.S. patent application Ser. No. 18/901,532, filed on Sep. 30, 2024, entitled “SUBSTRATE TRANSFER APPARATUS AND SUBSTRATE TRANSFER METHOD” are incorporated herein by reference.

1. A substrate transfer apparatus comprising:
an end effector comprising:
a hand that grips a substrate; and
a plunger that comes into contact with the substrate and performs alignment of the substrate comprising a contact portion that comes into contact with the substrate by moving in a substrate direction, wherein
the contact portion comprises a contact bottom surface that comes into contact with the substrate and is inclined so that a thickness decreases toward a tip of the contact portion.

2. The substrate transfer apparatus according to claim 1, wherein
the contact portion comprises:
a contact boundary surface connected to the contact bottom surface; and
a contact side surface connected to the contact boundary surface and arranged substantially vertical.

3. The substrate transfer apparatus according to claim 2, wherein
after the bottom surface of the substrate is in contact with the substrate, the substrate transfer apparatus further moves the contact portion in the substrate direction, so that the substrate is gripped by the contact side surface.

4. The substrate transfer apparatus according to claim 3, wherein
the contact side surface comprises a curved surface.

5. The substrate transfer apparatus according to claim 4, wherein
the contact bottom surface comprises a curved surface.

6. The Substrate transfer apparatus according to claim 1, further comprising
a drive unit that drives the contact portion.

7. The substrate transfer apparatus according to claim 6, wherein
the drive unit comprises a cylinder, and the contact portion is driven by power from the cylinder.

8. The substrate transfer apparatus according to claim 1, wherein
the hand comprises a plurality of substrate contact portions arranged at a tip and a bottom of the hand.

9. The substrate transfer apparatus according to claim 8, wherein
a substrate contact portion of the plurality of substrate contact portions that is arranged at the tip comprises:
a contact boundary surface connected to the contact bottom surface; and
a contact side surface connected to the contact boundary surface and arranged substantially vertical.

10. The substrate transfer apparatus according to claim 9, wherein
a substrate contact portion of the plurality of substrate contact portion arranged at the bottom comprises:
a contact boundary surface connected to the contact bottom surface; and
a contact side surface connected to the contact boundary surface and arranged substantially vertical.

11. A substrate transfer method comprising:
moving a contact portion driven by a plunger in a substrate direction;
contacting a substrate with a contact bottom surface of the contact portion, wherein the contact bottom surface is inclined so that its thickness decreases toward a tip of the substrate;
moving the contact portion in the substrate direction by the plunger, the substrate is in contact with a contact side of a contact side surface; and
gripping the substrate with the contact side surface.

12. The substrate transfer method according to claim 11, wherein
the contact side surface comprises a curved surface.

13. The substrate transfer method according to claim 11, wherein
the contact bottom surface comprises a curved surface.
